(19) United States
(12) Patent Application Publication
(10) Pub. No.: US 2024/0046860 A1
(43) Pub. Date: Feb. 8, 2024

(54) DISABLING TRANSITIONS WHEN ENCODED INTENSITY IS LOW

(71) Applicant: GOOGLE LLC, Mountain View, CA (US)

(72) Inventors: Sangmoo CHOI, Mountain View, CA (US); Daniel SOLOMON, Mountain View, CA (US)

(21) Appl. No.: 18/275,116

(22) PCT Filed: May 10, 2021
(86) PCT No.: PCT/US21/70522

§ 371 Date: Jul. 31, 2023

(51) Int. Cl. G09G 3/3225

(52) U.S. Cl. CPC G09G 3/3225; G09G 2320/0613; G09G 2320/0686; G09G 2340/0435; G09G 2320/0247; G09G 2320/0666; G09G 2360/16

(57) ABSTRACT

A method can include determining that a first frame for display on an emissive display meets a low encoded intensity condition; based on the determination that the first frame meets the low encoded intensity condition, disabling refresh rate transitions when displaying multiple frames on the emissive display; while the refresh rate transitions are disabled, maintaining a refresh rate while changing a graphic intensity; determining that a second frame does not meet the low encoded intensity condition; based on the determination that the second frame does not meet the low encoded intensity condition, enabling refresh rate transitions when displaying multiple frames on the emissive display; and while the refresh rate transitions are enabled, changing the refresh rate for the emissive display based on the graphic intensity changing.

### TECHNICAL FIELD

This description relates to graphics processing.

### BACKGROUND

Displays on computing systems can have modifiable refresh rates, or rates of updating or changing pixel content. Lower refresh rates can reduce power consumption, increasing battery life, whereas higher refresh rates can improve graphical output.

### SUMMARY

According to an example, a method can include determining that a first frame for display on an emissive display meets a low encoded intensity condition; based on the determination that the first frame meets the low encoded intensity condition, disabling refresh rate transitions when displaying multiple frames on the emissive display; while the refresh rate transitions are disabled, maintaining a refresh rate while changing a graphic intensity; determining that a second frame does not meet the low encoded intensity condition; based on the determination that the second frame does not meet the low encoded intensity condition, enabling refresh rate transitions when displaying multiple frames on the emissive display; and while the refresh rate transitions are enabled, changing the refresh rate for the emissive display based on the graphic intensity changing.

According to an example, the low encoded intensity transmission can include a predefined encoded intensity threshold. According to an example, the low encoded intensity condition can include at least a predefined proportion of pixels having encoded intensities equal to or less than a predefined encoded intensity threshold.

According to an example, the predefined proportion can be based on a brightness level of the display when displaying the respective frame.

According to an example, the encoded intensities of the pixels can be determined based on a weighted average of red values, green values, and blue values, the green values being preferably weighted more heavily than the red values and being preferably weighted more heavily than the blue values.

According to an example, the low encoded intensity condition can include a sum of band values meeting a predefined sum threshold. The sum of band values can include a number of pixels with encoded intensities within a first range multiplied by a first weighting factor plus a number of pixels with encoded intensities within a second range multiplied by a second weighting factor.

According to an example, the predefined sum threshold can be based on a brightness level of the display on which the graphic intensity changes.

According to an example, the method can further include determining that a third frame meets the low encoded intensity condition, the third frame being displayed consecutively after the first frame and before the second frame, wherein the disablement of refresh rate transitions is based on the first frame meeting the low encoded intensity condition and the third frame meeting the low encoded intensity condition.

According to an example, the method can further include determining that a third frame does not meet the low encoded intensity condition, the third frame being displayed consecutively after the second frame, wherein the enablement of the refresh rate transitions is based on the determination that the second frame does not meet the low encoded intensity condition and the determination that the third frame does not meet the low encoded intensity condition.

According to an example, the emissive display can include an active-matrix organic light-emitting diode (AMOLED) display.

According to an example, the method can further include changing a peak luminance of at least one pixel after changing the refresh rate.

According to an example, the graphic intensity can change based on a change of a type of application presented by a display.

According to an example, a method can include determining that a first frame for display on an emissive display meets a low encoded intensity condition; based on the determination that the first frame meets the low encoded intensity condition, setting a delay of refresh rate transitions when displaying multiple frames on the emissive display to a first time period; after expiration of the first time period, changing a refresh rate for the emissive display from a first frequency to a second frequency based on a first change of a graphic intensity; determining that a second frame does not meet the low encoded intensity condition; based on the determination that the second frame has not met the low encoded intensity condition, changing the delay of refresh rate transitions to a second time period, the second time period being shorter than the first time period; and after expiration of the second time period, changing the refresh rate from the second frequency to the first frequency based on a second change of the graphic intensity.

According to an example, the low encoded intensity condition can include at least at least a predefined proportion of pixels having encoded intensities equal to or less than a predefined encoded intensity threshold.

According to an example, the low encoded intensity condition an include a sum of band values meeting a predefined sum threshold. The sum of band values can include a number of pixels with encoded intensities within a first range multiplied by a first weighting factor plus a number of pixels with encoded intensities within a second range multiplied by a second weighting factor.

According to an example, a non-transitory computer-readable storage medium can include instructions stored thereon that, when executed by at least one processor, are configured to cause a computing system to perform any of the above example methods.

According to an example, a computing system can include at least one processor, and a non-transitory computer-readable storage medium. The non-transitory computer-readable storage medium can comprise instructions stored thereon that, when executed by the at least one processor, are configured to cause the computing system to perform any of the above example methods.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram showing frames transition between different refresh rates according to an example implementation.

FIG. 2A shows luminance values for a pixel at a first refresh rate and a second refresh rate according to an example implementation.

FIG. 2B shows luminance values for a pixel at a first refresh rate and a second refresh rate according to another example implementation.

FIG. 3 shows a graph with luminance changes as a function of encoded intensity according to an example implementation.

FIG. 4A shows a display presenting a frame with high encoded intensity according to an example implementation.

FIG. 4B shows a histogram with encoded intensity levels for the pixels shown in the display of FIG. 4A according to an example implementation.

FIG. 5A shows a display presenting a frame with low encoded intensity according to an example implementation.

FIG. 5B shows a histogram with encoded intensity levels for the pixels shown in the display of FIG. 5A according to an example implementation.

FIG. 6A shows the histogram of FIG. 4B with a first predefined encoded intensity threshold according to an example implementation.

FIG. 6B shows the histogram of FIG. 4B with a second predefined encoded intensity threshold according to an example implementation.

FIG. 7 is a diagram showing frames transition between encoded intensities and a delay in disabling refresh rate transitions when displaying multiple frames on an emissive display according to an example implementation.

FIG. 8 is a flowchart showing a method performed by a computing system according to an example implementation.

FIG. 9 is a flowchart showing a method performed by a computing system according to an example implementation.

FIG. 10 is a block diagram showing a computing system according to an example implementation.

FIG. 11 is a flowchart showing a method performed by a computing system according to an example implementation.

FIG. 12 is a flowchart showing a method performed by a computing system according to an example implementation.

FIG. 13 shows an example of a computer device and a mobile computer device that can be used to implement the techniques described here.

Like reference symbols in the various drawings indicate like elements.

### DETAILED DESCRIPTION

A refresh rate of a display can represent a rate and/or frequency at which rows of pixels in the display are refreshed, and/or receive signals that cause the pixels to generate an image. A higher refresh rate can improve image quality in applications with high graphic intensity in which the image changes frequently, such as video applications or video game applications. A lower refresh rate can provide satisfactory image quality in applications with low graphic intensity in which the image changes less frequently, such as productivity applications or photographs, and can reduce power consumption. The refresh rate can be changed depending on whether the display is presenting an application with high graphic intensity or low graphic intensity. Graphic intensity can be based on a rate at which the image content of successive frames changes.

However, changing the refresh rate can cause a refresh rate transition flicker to appear on the display due to a change in luminance caused by the change in refresh rate. Some of these refresh rate transition flickers can be ameliorated by reducing a peak signal at some pixels. However, this may not prevent the refresh rate transition flicker when an encoded intensity, such as a gray level, of the image presented by the display is low.

To prevent the refresh rate transition flicker, in some examples, a computing system can disable and/or delay refresh rate transitions when (consecutively) displaying multiple frames on an emissive display when the image, represented by a frame, meets a low encoded intensity condition. While refresh rate transitions when displaying multiple frames, e.g., consecutive frames, on the emissive display are disabled, the computing system can maintain a same refresh rate even though graphic intensity at the display changes. The low encoded intensity condition can represent a proportion of pixels with low encoded intensity. In some examples, the computing system can delay refresh rate transitions when the image meets the low encoded intensity condition. The computing system can enable refresh rate transitions when the low encoded intensity condition is not met, and/or shorten the delay when the low encoded intensity condition is not met.

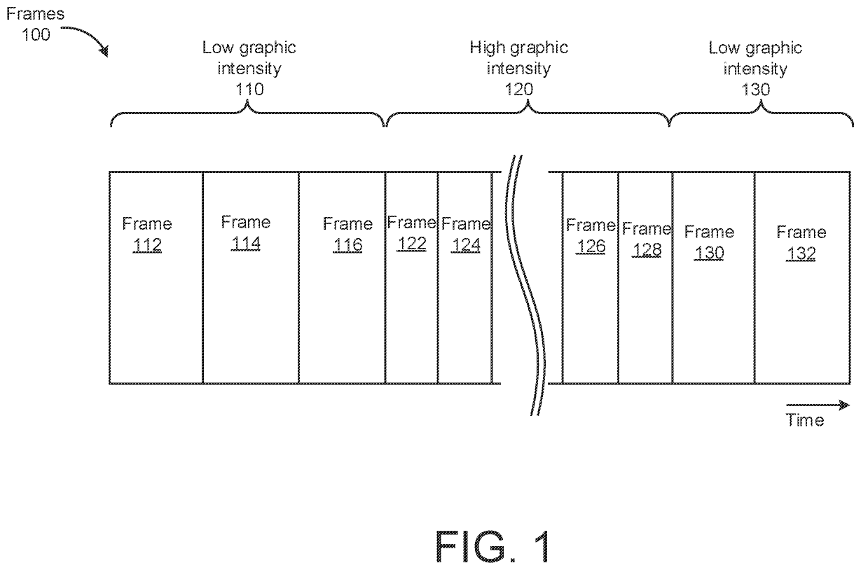

FIG. 1 is a diagram showing frames 100 for display on an emissive display transitioning between different refresh rates according to an example implementation. For frames 112, 114, 116 presenting image content with low graphic intensity 110, such as image content presented by productivity applications (such as email applications, word processing applications, or spreadsheet applications) or still image or photograph applications, a display can present the frames 112, 114, 116 with a low refresh rate, such as sixty Hertz (60 Hz). When the display transitions to presenting frames 122, 124, 126, 128 that have image content with high graphic intensity 120, such as image content presented by video applications or video game applications, the display can transition the refresh rate to a relatively high refresh rate, such as one hundred twenty Hertz (120 Hz). The transition to the higher refresh rate can improve the quality of the displayed video and/or presented images, but can increase power consumption. When the display transitions back to presenting frames 132, 134 with low graphic intensity 130, the display can transition the refresh rate back to the low refresh rate, such as sixty Hertz (60 Hz), reducing power consumption. The lower refresh rate and/or reduced power consumption can extend the battery life of a battery included in a computing system that includes the display.

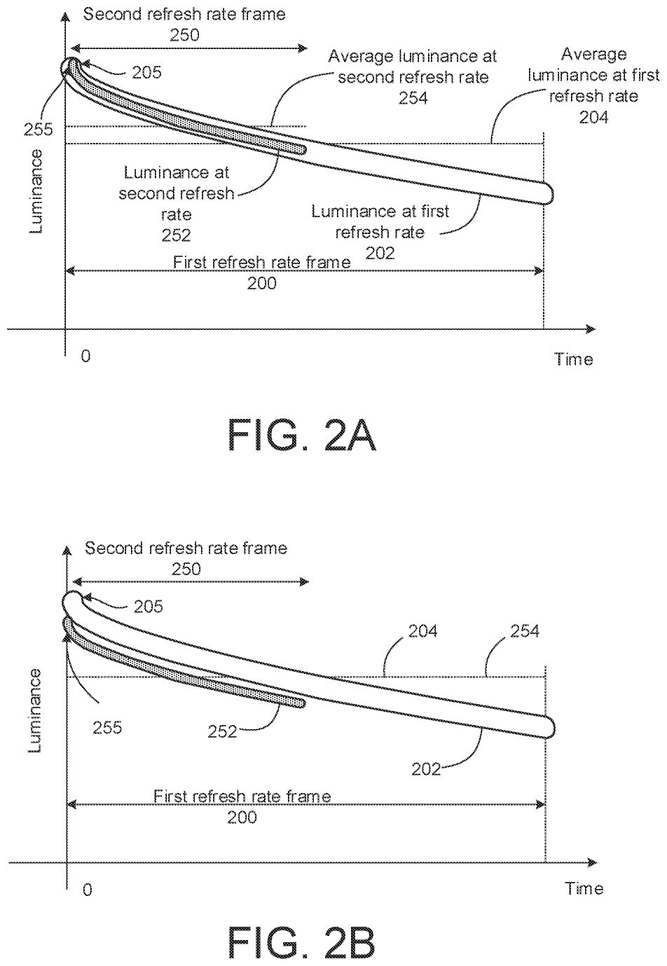

FIG. 2A shows luminance values for a pixel at a first refresh rate and a second refresh rate according to an example implementation. The time shown in FIG. 2A is relative to the time of a pixel row being updated to a new image in response to the row signals and/or pulses provided to the pixel. In some examples, as used herein, a “first refresh rate” can indicate a lower refresh rate such as sixty Hertz (60 Hz) with which the frames 112, 114, 116, 132, 134 were presented, and a “second refresh rate” can indicate a higher refresh rate such as one hundred twenty Hertz (120 Hz) with which the frames 122, 124, 126, 128 were presented, although the second refresh rate does not need to be exactly twice the first refresh rate.

In the example shown in FIG. 2A, the luminance 202, 252 declines after the peak luminance 205, 255 for both the first refresh rate and the second refresh rate. However, at the second refresh rate, which is higher than the first refresh rate, the luminance 252 stops declining and returns to the peak luminance sooner when the next frame starts. The shorter period of declining luminance 252 for the second refresh rate, as compared with the period of declining luminance 202 for the first refresh rate, causes an average luminance at the second refresh rate 254 to be higher and/or greater than the average luminance at the first refresh rate 204. The mismatch of the average luminance 204, 254 between two different refresh rates can cause optical artifacts in the display while the display is dynamically transitioning the refresh rate.

FIG. 2B shows luminance values for a pixel at a first refresh rate and a second refresh rate according to another example implementation. As in the example shown in FIG. 2A, the luminance at the second refresh rate 252 stops declining and returns to the peak sooner than the luminance at the first refresh rate 202. However, in this example, the peak luminance 255 at the second refresh rate is adjusted downward and/or is reduced compared to and/or relative to the peak luminance 205 at the first refresh rate. The downward adjustment of the peak luminance 255 at the second refresh rate causes the average luminance at the second refresh rate 254 to be equal to, and/or the same as, the average luminance at the first refresh rate 204. The downward adjustment of the peak luminance 255 can mitigate the optical artifacts caused by the luminance mismatches between different refresh rates. However, for pixels with lower encoded intensities and/or gray levels, the downward adjustment of the peak luminance 255 may not sufficiently mitigate the optical artifacts caused by changing and/or transitioning the refresh rate, resulting in a flicker effect when the refresh rate is transitioned and/or changed.

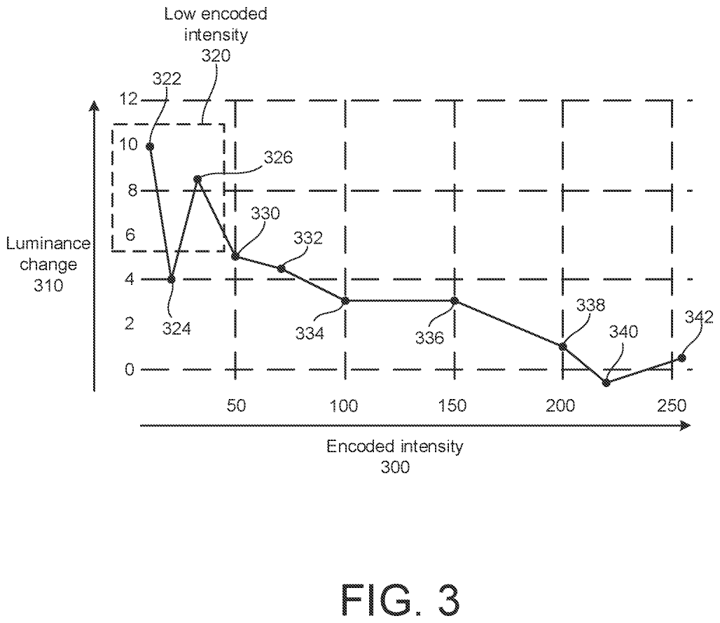

FIG. 3 shows a graph with luminance changes 310 as a function of encoded intensity 300 according to an example implementation. At the low levels of encoded intensity, such as below fifty (50), the luminance changes when the refresh rate is changed can be unsatisfactorily high, even after changing the luminance by reducing the peak luminance 255, as described with respect to FIG. 2B.

An encoded intensity can be based on pixel values sent, outputted, and/or provided to a display, such as red, green, and blue values in an RGB color model. An example of an encoded intensity level can be a gray level. The gray level can be an average value of the color components, such as red, green, and blue, for a pixel in the RGB color model, or a weighted average, such as 0.299 times the red value, plus 0.587 times the green value, plus 0.114 times the blue value in the RGB color model. In the YCbCr color model, the gray value and/or encoded intensity can be the Y or luma component.

The luminance change 310 can occur when a refresh rate changes. As shown in FIG. 3, the luminance change 310 can be unsatisfactorily high for pixels 322, 326 with low encoded intensity 320. For other pixels 324, 330, 332, 334, 336, 338, 340, 342, the luminance change 310 when the refresh rate changes can be satisfactorily low. The high luminance change 310 for pixels 322, 326 with low encoded intensity can result in an undesirable transitional flicker when the refresh rate changes.

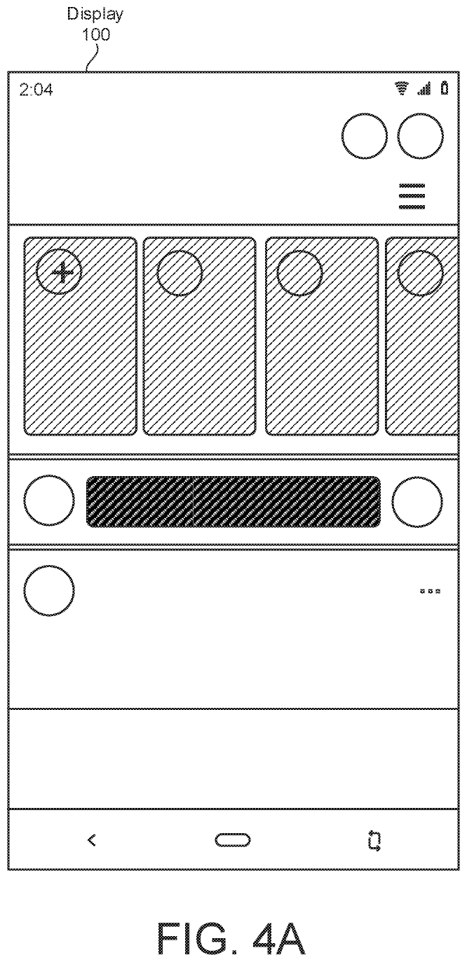

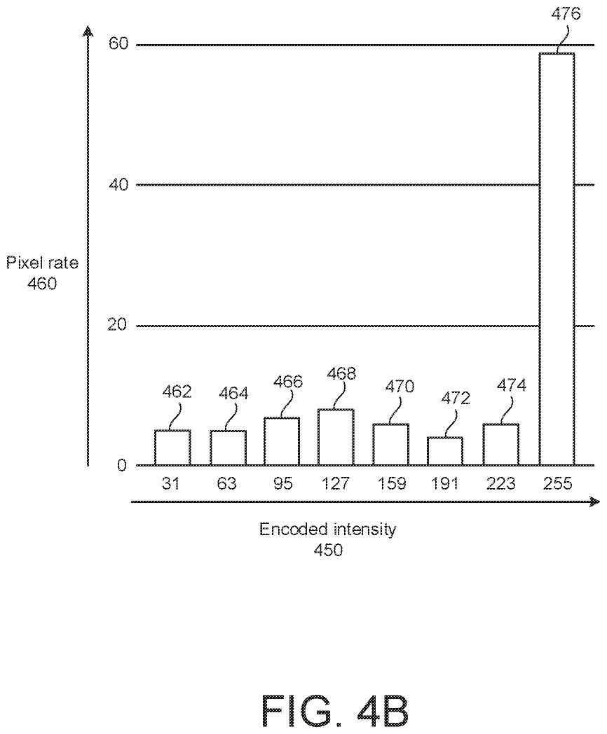

FIG. 4A shows a display 400 presenting a frame with high encoded intensity according to an example implementation. In some examples, the display 400 can include an active-matrix organic light-emitting diode (AMOLED) display. An AMOLED display is an example of an emissive display. The large proportion of pixels with white and/or light color indicates that the frame based on which the image shown in FIG. 4A was generated has high encoded intensity.

FIG. 4B shows a histogram with encoded intensity levels 450 for the pixels shown in the display 400 of FIG. 4A according to an example implementation. The pixel ratio 460 for each bar group 462, 464, 466, 468, 470, 472, 474, 476 indicates a percentage of pixels that have an encoded intensity 450 and/or gray level that is equal to or less than the indicated value and greater than the preceding value. In some examples, the encoded intensity levels 450 and/or gray levels can range in value from zero (0) to two hundred fifty six (256). As shown in FIG. 4B, the pixel ratios 460 for bar groups 462, 464 with low encoded intensity is low, indicating that the frame shown in FIG. 4A and represented by the histogram of FIG. 4B does not have a low encoded intensity, and/or a low encoded intensity condition will not be met for the frame shown in FIG. 4A and represented by the histogram of FIG. 4B.

In some examples, the frame shown in FIG. 4A and represented by the histogram of FIG. 4B that did not meet the low encoded intensity condition can be considered a second frame. Based on the second frame not meeting the low encoded intensity condition, a computing system that includes the display 400 can enable refresh rate transitions when displaying multiple frames on an emissive display.

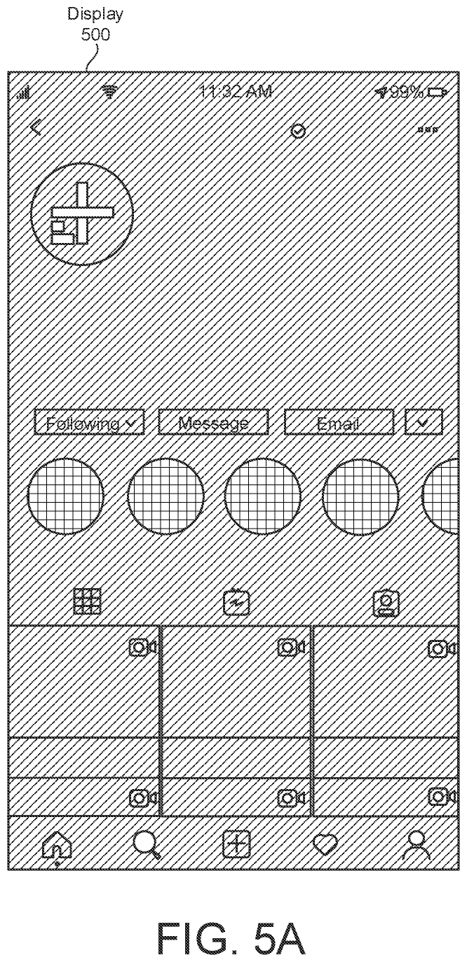

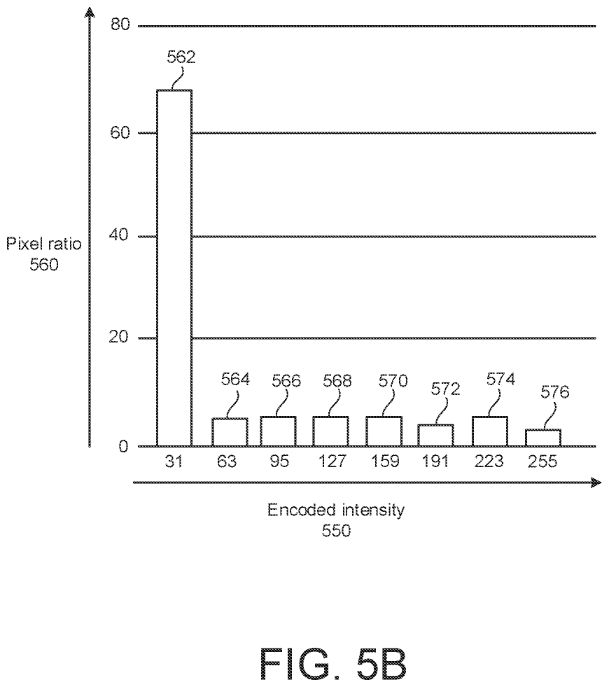

FIG. 5A shows a display 500 presenting a frame with low encoded intensity according to an example implementation. In some examples, the display 500 can include an active-matrix organic light-emitting diode (AMOLED) display. An AMOLED display is an example of an emissive display. The large proportion of pixels with black and/or dark color indicates that the frame based on which the image shown in FIG. 5A was generated has low encoded intensity.

FIG. 5B shows a histogram with encoded intensity levels 550 for the pixels shown in the display 500 of FIG. 5A according to an example implementation. The pixel ratio 560 shown in FIG. 5B can have similar features to the pixel ratio 460 shown in FIG. 4B. The encoded intensity levels 550 shown in FIG. 5B can have similar features to the encoded intensity levels 450 shown in FIG. 4B. As shown in FIG. 5B, the pixel ratio for the lowest bar group 562, with encoded intensities of thirty-one (31) or less, is high, greater than sixty percent (60%), indicating that the frame shown in FIG. 5A and represented by the histogram of FIG. 5B does have a low encoded intensity, and/or a low encoded intensity condition will be met for the frame shown in FIG. 5A and represented by the histogram of FIG. 5B.

In some examples, the frame shown in FIG. 5A and represented by the histogram of FIG. 5B that met the low encoded intensity condition can be considered a first frame. Based on the first frame meeting the low encoded intensity condition, a computing system that includes the display 500 can disable refresh rate transitions when displaying multiple frames on an emissive display.

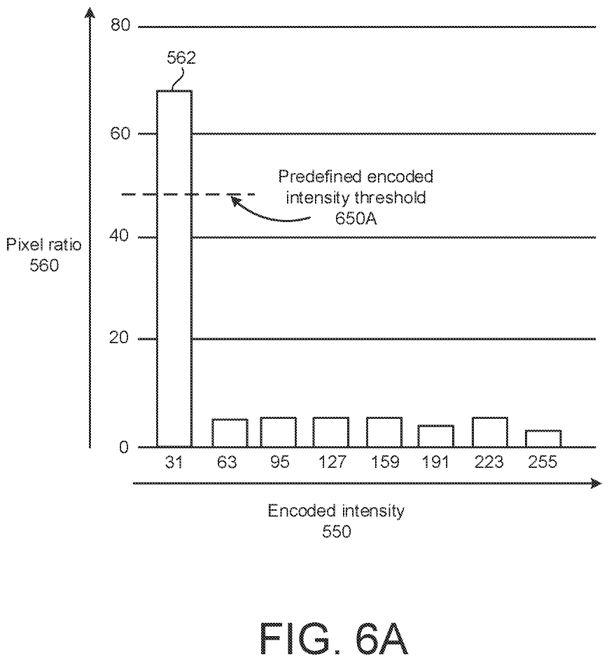

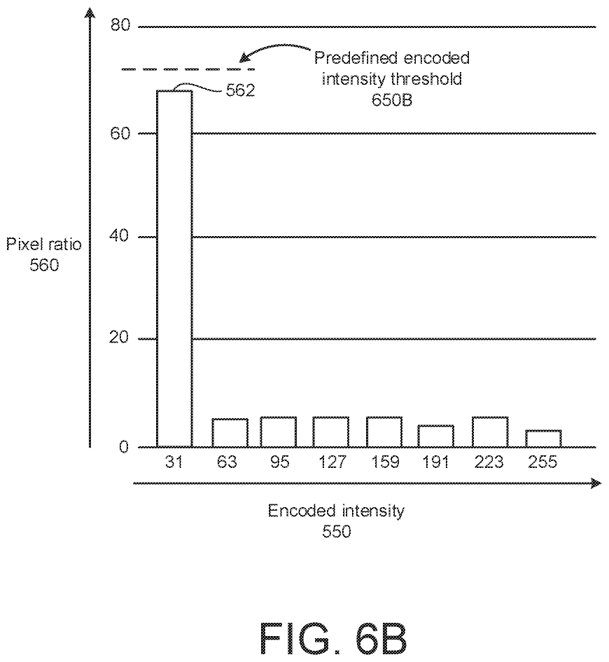

FIG. 6A shows the histogram of FIG. 5B with a first predefined encoded intensity threshold 650A according to an example implementation. In this example, the brightness setting of the display is intermediate between a high encoded threshold value and a low encoded threshold value, and a first predefined encoded intensity threshold 650A for the lowest bar group 562, and/or range, for pixels with encoded intensity levels less than thirty-two (32) and/or less than or equal to thirty-one (31), that is fifty percent (50%). In this example, the encoded intensity 550 of the lowest bar group 562 is greater than the predefined encoded intensity threshold 650A. Based on the encoded intensity 550 of the lowest bar group 562 being greater than the predefined encoded intensity threshold 650A, the low encoded intensity condition is met for the frame shown in FIG. 5A and as represented by FIG. 5B for the first predefined encoded intensity threshold 650A.

FIG. 6B shows the histogram of FIG. 5B with a second predefined encoded intensity threshold 650B according to an example implementation. In this example, the brightness setting of the display is high, and the second predefined encoded intensity threshold 650B for the lowest bar group 562, and/or range, for pixels with encoded intensity levels less than thirty-two (32) and/or less than or equal to thirty-one (31), is seventy percent (70%). In this example, the encoded intensity 550 of the lowest bar group 562 is less than the predefined encoded intensity threshold 650B. Based on the encoded intensity 550 of the lowest bar group 562 being less than the predefined encoded intensity threshold 650B, the low encoded intensity condition is not met for the frame shown in FIG. 5A and represented by FIG. 5B for the second predefined encoded intensity threshold 650B.

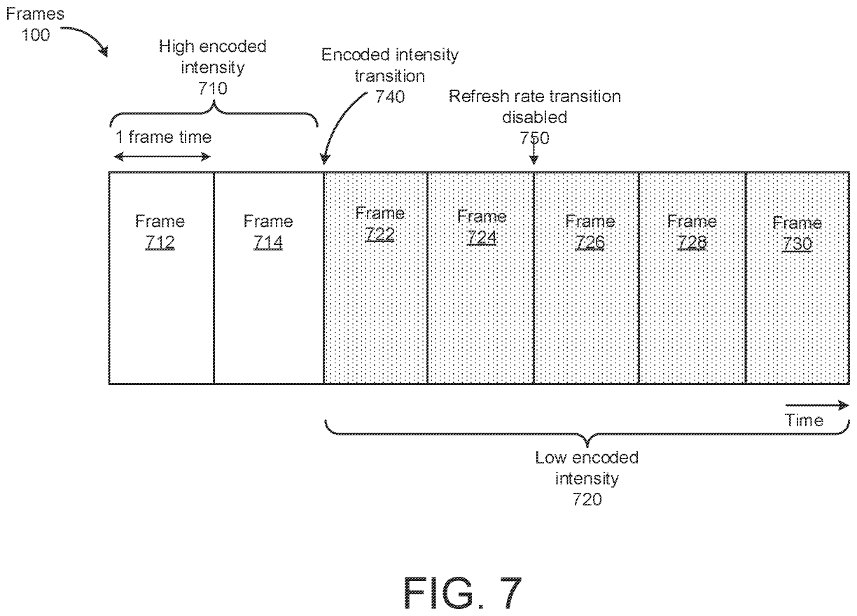

FIG. 7 is a diagram showing frames 712, 714, 722, 724, 726, 728, 730 transition between encoded intensities 710, 720 and a delay 745 in disabling refresh rate transitions 750 according to an example implementation. In this example, frames 712, 714 can have a high encoded intensity 710, such as less than a predefined proportion of the pixels having encoded intensities equal to or less than a predefined encoded intensity threshold, and/or frames 712, 714 that do not meet the low encoded intensity condition. While the computing system presents frames 712, 714 with high encoded intensity 710, the computing system can enable refresh rate transitions. However, after the computing system begins presenting frames 722, 724 with low encoded intensity, and/or frames 722, 724, 726, 728, 730 that meet the low encoded intensity condition, the computing system can disable refresh rate transitions 750.

In some examples, the computing system can disable refresh rate transitions only after a predetermined number, such as a number greater than one, of consecutive frames has met the low encoded intensity condition. In the example shown in FIG. 7, the computing system disables refresh rate transitions 750 after two consecutive frames 722, 724 meet the low encoded intensity condition.

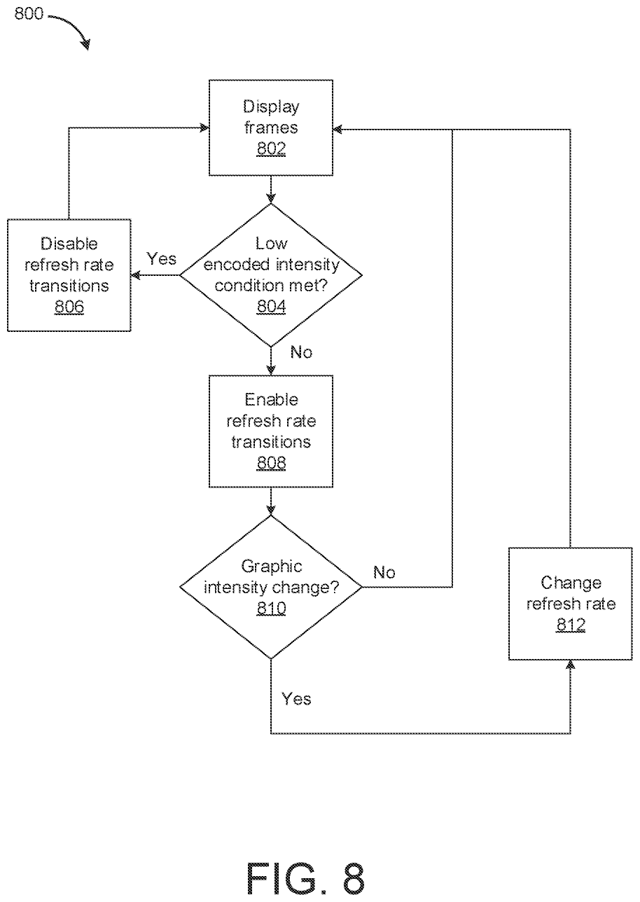

FIG. 8 is a flowchart showing a method 800 performed by a computing system according to an example implementation. The method 800 can include displaying frames (802). The computing system can display the frames (802), such as on either of the displays 400, 500 described above. The displayed frames can include any of the frames described above.

After, and/or while, displaying the frames (802), the computing system displays the frames (802), the computing system can determine whether a low encoded intensity condition is met (804). In some examples, the computing system can determine whether the low encoded intensity condition is met for a next frame to be displayed. In some examples, the computing system can determine whether the low encoded intensity condition is met for a frame to be displayed at some future time, or a predetermined number of frames after the frame currently being displayed.

If the computing system determines that the low encoded intensity condition is and/or was met, then the computing system can disable refresh rate transitions (806). While the refresh rate transitions are disabled, the computing system will continue displaying frames (802), will not change the refresh rate, will maintain a same refresh rate, and/or the refresh rate will remain at the same frequency as when the refresh rate transitions were disabled, even if the graphic intensity changes, until determining that the low encoded intensity condition is no longer met.

If the computing system determines that the low encoded intensity condition has not been met, then the computing system can enable refresh rate transitions (808). While refresh rate transitions are enabled, the computing system can determine whether a graphic intensity has changed (810). If the computing system determines that the graphic intensity has not changed, then the computing system can continue displaying frames (802) at the same refresh rate. If the computing system determines that the graphic intensity has changed, then the computing system can change the refresh rate (812) and then continue displaying frames (802). In some examples, the computing system can change the refresh rate (812) by increasing the refresh rate if a graphic intensity has increased, and/or by decreasing the refresh rate if the graphic intensity has decreased.

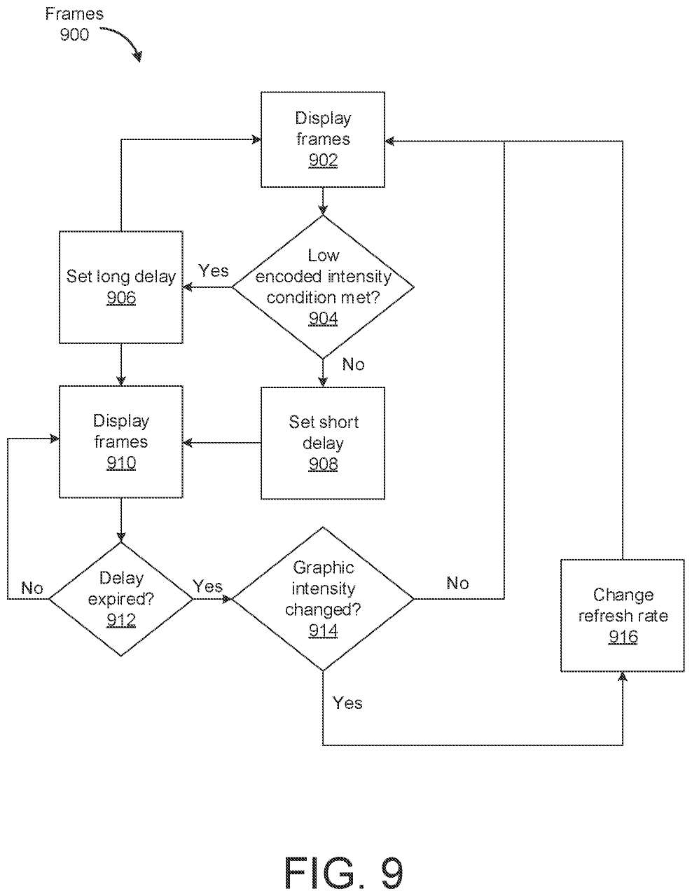

FIG. 9 is a flowchart showing a method 900 performed by a computing system according to an example implementation. The method 900 can include the computing system displaying frames (902). The computing system can display the frames (902), such as on either of the displays 400, 500 described above. The displayed frames can include any of the frames described above.

After, and/or while, displaying the frames (902, the computing system can determine whether a low encoded intensity condition is met (904). In some examples, the computing system can determine whether the low encoded intensity condition is met for a next frame to be displayed. In some examples, the computing system can determine whether the low encoded intensity condition is met for a frame to be displayed at some future time, or a predetermined number of frames after the frame currently being displayed. The computing system can set a delay for changing a refresh rate based on whether the low encoded intensity condition was met.

If the low encoded intensity condition was met, then the computing system can set a relatively long delay (906). If the low encoded intensity condition was not met, then the computing system can set a relatively short delay (908). The short delay can be aa shorter time period than the long delay, and/or the long delay can be a longer time period than the short delay. The computing system can set a delay of refresh rate transitions to a time period, such as a first time period or a second time period, which can be equal to either the long delay or the short delay. In some examples, the computing system can set the delay to one of multiple time periods depending on the encoded intensity. In some examples, the computing system can disable refresh rate transitions when the encoded intensity is in a first, highest range, and enable the refresh rate transitions but set a delay for the refresh rate transitions when the encoded intensity is in one of one or more other encoded intensity ranges, with lower encoded intensity ranges having shorter delay time periods than higher encoded intensity ranges.

The computing system can continue displaying frames (910) until the delay has expired. The computing system can determine whether the delay has expired (912). If the delay has not expired, the computing system can continue displaying frames (910) and maintain a same refresh rate, even if the graphic intensity changes.

After the delay has expired, the computing system can determine whether a graphic intensity has changed (914). The computing system can determine whether the graphic intensity has changed (914) based on whether the computing system is displaying an application with a higher or lower graphic intensity than the computing system was previously displaying when the refresh rate was last set and/or adjusted. If the graphic intensity has not changed, then the computing system can continue displaying frames (902).

If the graphic intensity has changed, then the computing system can change the refresh rate (916). In some examples, the computing system can change and/or set the refresh rate (916) based on a graphic intensity of graphics outputted by the display 400, 500, such as a frequency at which an image presented by the display 400, 500 changes. In some examples, the computing system can change and/or set the refresh rate (916) based on a type of application presented by the by the display 400, 500 and/or computing system, such as a high refresh rate when a high graphic intensity type of application such as video application or video game application is presented and a low refresh rate when a low intensity type of application such as a productivity application or web browser application is presented, as non-limiting examples.

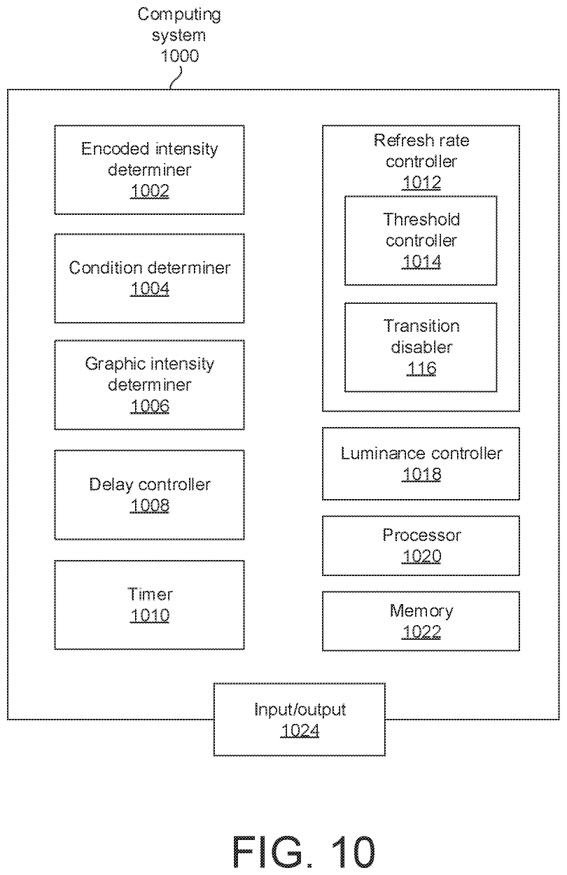

FIG. 10 is a block diagram showing a computing system 1000 according to an example implementation. The computing system 1000 can include and/or present the display 400, 500 shown in FIGS. 4 and 5.

The computing system 1000 can include an encoded intensity determiner 1002. The encoded intensity determiner 1002 can determine encoded intensities and/or frames. In some examples, the encoded intensity can represent a gray level. The encoded intensity determiner 1002 can determine encoded intensities and/or gray levels based on color values for pixels. In some examples, the encoded intensities can be represented by bytes and have values between 0 and 255. In some examples, the encoded intensity determiner 1002 can determine the encoded intensities based on a sum of red values, green values, and blue values. In some examples, based on human eyes being most sensitive to green light, the encoded intensity determiner 1002 can determine the encoded intensities based on a weighted average of red values, green values, and blue values, with the green values being weighted more heavily than the red values and the green values being weighted more heavily than the blue values.

The computing system 1000 can include a condition determiner 1004. The condition determiner 1004 can determine whether a frame, and/or multiple frames, meet a low encoded intensity condition. The low encoded intensity condition can be based on the encoded intensities, and/or encoded intensity levels, of pixels in a frame.

In some examples, the condition determiner 1004 can determine whether a predefined proportion of pixels in a frame have encoded intensities equal to or less than a predefined encoded intensity threshold. In some examples, the predefined encoded intensity threshold can be based on a brightness level of the display. Because the transitional flickering due to luminance mismatching can become weaker when the brightness setting of the display is higher, the predefined proportion, and/or threshold number of pixels, to determine whether the low encoded intensity condition is met, can be higher and/or relaxed when the brightness setting is higher, and/or lower and/or stricter when the brightness setting is lower. In the example of FIG. 6A, the encoded intensity condition is for at least fifty percent (50%) of the pixels in the frame to have encoded intensities of thirty-one (31) or less, and/or encoded intensities between zero (0) and thirty-one (31), inclusive. In the example of FIG. 6B, in which the brightness setting is higher than in the example of FIG. 6A, the encoded intensity condition is for at least seventy percent (70%) of the pixels in the frame to have encoded intensities of thirty-one (31) or less, and/or encoded intensities between zero (0) and thirty-one (31), inclusive.

In some examples, the low encoded intensity condition can include determining whether a sum of band values meets a predefined sum threshold. For example, the sum of band values can include a number of pixels with encoded intensities within a first range (such as between zero and thirty-one) multiplied by a first weighting factor, a number of pixels within a second range (such as between thirty-two and sixty-three) multiplied by a second weighting factor, and/or a number of pixels within a third range (such as between sixty-four and ninety-three) multiplied by a third weighting factor. In some examples, the weighting factor can be based on the brightness setting of the display (allowing the predefined sum threshold to remain the same regardless of the brightness setting), with higher brightness settings having lower weighing factors and lower brightness settings having higher weighting factors. Weighting factors for ranges with higher encoded intensities can be lower than weighing factors for ranges with lower encoded intensities.

In an example, when the brightness setting is medium and/or middle, the first weighting factor can be 0.8, the second weighting factor can be 0.15, and the third weighting factor can be 0.05. In this example, using the pixel ratios 560 shown in FIG. 6A, the sum of band values is 68*0.8+5*0.15+5*0.5=55, which is greater than a predefined sum threshold of 50, causing the computing system 1000 to disable refresh rate transitions.

In an example, when the brightness setting is high, the first weighting factor can be 0.3, the second weighting factor can be 0.05, and the third weighting factor can be 0.02. In this example, using the pixel ratios 560 shown in FIG. 6A, the sum of band values is 68*0.3+5*0.05+5*0.2=21, which is greater than a predefined sum threshold of 50, causing the computing system 1000 to not disable, and/or enable, refresh rate transitions.

The computing system 1000 can include a graphic intensity determiner 1006. The graphic intensity determiner 1006 can determine graphic intensities of frames, and/or series of frames, presented by the display 400, 500. In some examples, the graphic intensity can be based on a rate at which the image content of successive frames changes. The graphic intensity determiner 1006 can determine the rate at which the image content of successive frames changes based on a current and previous and/or next frame, and/or based on a predetermined number of frames, the predetermined number being greater than one. In some examples, the graphic intensity determiner 1006 can determine a refresh rate, such as sixty Hertz (60 Hz), ninety Hertz (90 Hz), or one hundred twenty Hertz (120 Hz) that corresponds to the graphic intensity determined by the graphic intensity determiner 1006.

In some examples, the graphic intensity determiner 1006 can determine the graphic intensity based on a type of application presented by the display 400, 500 of the computing system 1000.

The computing system 1000 can include a delay controller 1008. The delay controller 1008 can set a delay (which can also be considered a time period) for changing a refresh rate. The delay controller 1008 can, for example, set a long delay for changing a refresh rate when encoded intensity of a frame is low, and/or when a frame meets a low encoded intensity condition. The delay controller 1008 can set a short delay for changing the refresh rate when encoded intensity of a frame is high, and/or when the frame does not meet the low encoded intensity condition.

The computing system 1000 can include a timer 1010. The timer 1010 can include a clock. The timer 1010 can compare the delay determined by the delay controller 1008 to the clock to determine whether the delay time has expired. In some examples, the delay controller 1008 and/or a refresh rate controller 1012 can prevent the refresh rate controller 1012 from changing the refresh rate until expiration of the delay.

The computing system 1000 can include the refresh rate controller 1012. The refresh rate controller 1012 can control the refresh rate of the display 400, 500, and/or the rate at which rows of pixels in the display are refreshed, and/or receive signals that cause the pixels to generate an image.

The refresh rate controller 1012 can change and/or set the refresh rate based on a graphic intensity determined by the graphic intensity determiner 1006. In some examples, the refresh rate controller 1012 can change the refresh rate only when the refresh rate controller 1012 has enabled refresh rate transitions, and/or when the refresh rate controller 1012 has not disabled refresh rate transitions. In some examples, the refresh rate controller 1012 can change the refresh rate only after the time period set by the delay controller 1008 has expired.

The refresh rate controller 1012 can include a threshold controller 1014. The threshold controller 1014 can control and/or set the predefined encoded intensity threshold 650A, 650B and/or the predefined sum threshold. The threshold controller 1014 can control and/or set the predefined encoded intensity threshold and/or the predefined sum threshold based on the brightness setting of the display. The threshold controller 1014 can, for example, set a higher predefined encoded intensity threshold and/or predefined sum threshold when the brightness is higher, and/or set a lower predefined encoded intensity threshold and/or predefined sum threshold when the brightness is lower.

The refresh rate controller 1012 can include a transition disabler 1016. The transition disabler 1016 can disable refresh rate transitions when one or more frames meets a low encoded intensity condition, and/or enable the refresh rate transitions when one or more frames does not meet the low encoded intensity condition. While refresh rate transitions are disabled, the refresh rate controller 1012 can maintain a same refresh rate, even when the graphic intensity determined by the graphic intensity determiner 1006 changes.

The computing system 1000 can include a luminance controller 1018. The luminance controller can change a peak luminance of at least one pixel after changing the refresh rate. The luminance controller 1018 can change and/or reduce the peak luminance to reduce a transitional flicker, as described above with respect to FIGS. 2A and 2B.

The computing system 1000 can include at least one processor 1020. The at least one processor 1020 can execute instructions, such as instructions stored in at least one memory device 1022, to cause the computing system 1000 to perform any combination of methods, functions, and/or techniques described herein, such as controlling an image presented by a display such as the display 400, 500, a refresh rate of the display, and/or a luminance of the image presented by the display.

The computing system 1000 can include at least one memory device 1022. The at least one memory device 1022 can include a non-transitory computer-readable storage medium. The at least one memory device 1022 can store data and instructions thereon that, when executed by at least one processor, such as the processor 1020, are configured to cause the computing system 1000 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 1000 can be configured to perform, alone, or in combination with the computing system 1000, any combination of methods, functions, and/or techniques described herein.

The computing system 1000 may include at least one input/output node 1024. The at least one input/output node 1024 may receive and/or send data, such as from and/or to, a server, and/or may receive input and provide output from and to a user. The input and output functions may be combined into a single node, or may be divided into separate input and output nodes. The input/output node 1024 can include, for example, a display such as the display 400, 500, a camera, a speaker, a microphone, one or more buttons, and/or one or more wired or wireless interfaces for communicating with other computing devices.

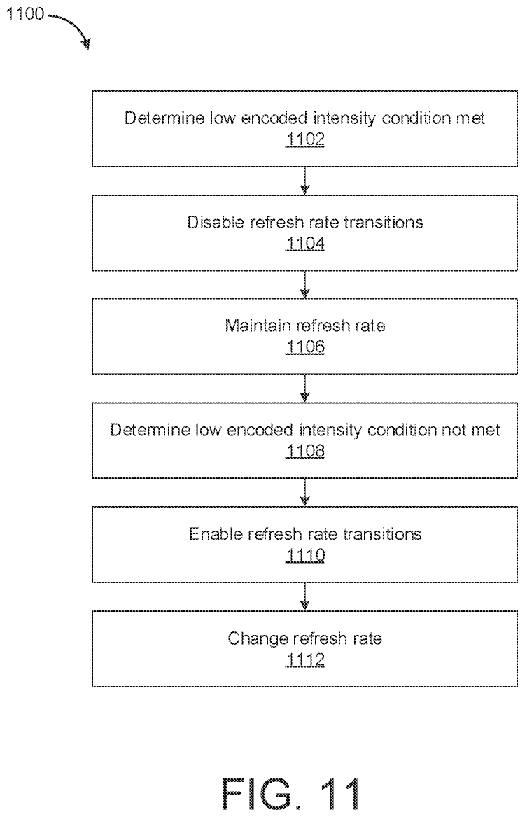

FIG. 11 is a flowchart showing a method 1100 performed by a computing system, such as the computing system 1000, according to an example implementation. The method 1100 can include determining that a first frame for display on an emissive display meets a low encoded intensity condition (1102). The method 1100 can include, based on the determination that the first frame meets the low encoded intensity condition, disabling refresh rate transitions when displaying multiple frames on the emissive display (1104). The method can include, while the refresh rate transitions are disabled, maintaining a refresh rate while changing a graphic intensity (1106). The method can include determining that a second frame does not meet the low encoded intensity condition (1108). The method can include, based on the determination that the second frame does not meet the low encoded intensity condition, enabling refresh rate transitions when displaying multiple frames on the emissive display (1110). The method can include, while the refresh rate transitions are enabled, changing the refresh rate for the emissive display based on the graphic intensity changing (1112).

According to some examples, the low encoded intensity condition can include a predefined encoded intensity threshold.

According to some examples, the low encoded intensity condition can include at least a predefined proportion of pixels having encoded intensities equal to or less than a predefined encoded intensity threshold.

According to some examples, the predefined proportion can be based on a brightness level of the display when displaying the respective frame.

According to some examples, the encoded intensities of the pixels can be determined based on a weighted average of red values, green values, and blue values. The green values can be weighted more heavily than the red values and can be weighted more heavily than the blue values.

According to some examples, the low encoded intensity condition can include a sum of band values meeting a predefined sum threshold. The sum of band values can include a number of pixels with encoded intensities within a first range multiplied by a first weighting factor plus a number of pixels with encoded intensities within a second range multiplied by a second weighting factor.

According to some examples, the predefined sum threshold can be based on a brightness level of the display on which the graphic intensity changes.

According to some examples, the method 1100 can further include determining that a third frame meets the low encoded intensity condition. The third frame can be displayed consecutively after the first frame and before the second frame. The disablement of refresh rate transitions can be based on the first frame meeting the low encoded intensity condition and the third frame meeting the low encoded intensity condition.

According to some examples, the method can further include determining that a third frame does not meet the low encoded intensity condition. The third frame can be displayed consecutively after the second frame. The enablement of the refresh rate transitions can be based on the determination that the second frame does not meet the low encoded intensity condition and the determination that the third frame does not meet the low encoded intensity condition.

According to some examples, the emissive display can be an active-matrix organic light-emitting diode (AMOLED) display.

According to some examples, the method 1100 can further include changing a peak luminance of at least one pixel after changing the refresh rate.

According to some examples, the graphic intensity can change based on a change of a type of application presented by a display.

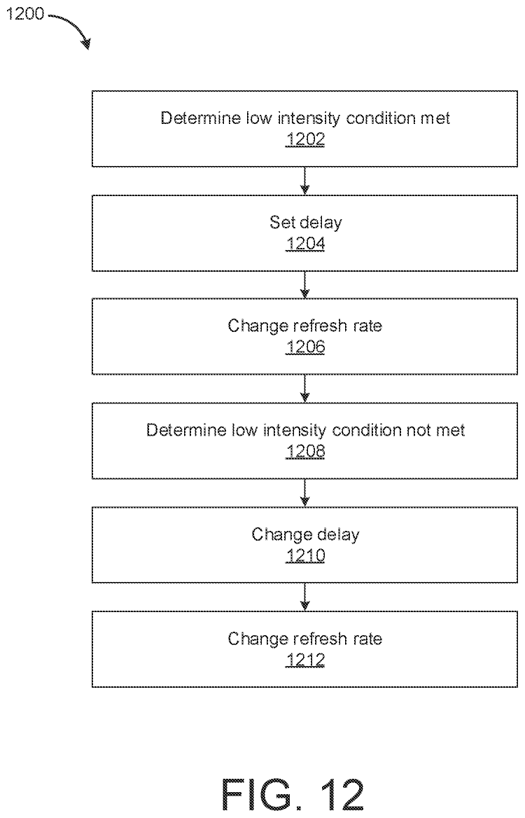

FIG. 12 is a flowchart showing a method 1200 performed by a computing system, such as the computing system 1000, according to an example implementation. The method 1200 can include determining that a first frame for display on an emissive display meets a low encoded intensity condition (1202). The method 1200 can include, based on the determination that the first frame meets the low encoded intensity condition, setting a delay of refresh rate transitions when displaying multiple frames on the emissive display to a first time period (1204). The method 1200 can include, after expiration of the first time period, changing a refresh rate for the emissive display from a first frequency to a second frequency based on a first change of a graphic intensity (1206). The method 1200 can include determining that a second frame does not meet the low encoded intensity condition (1208). The method 1200 can include, based on the determination that the second frame has not met the low encoded intensity condition, changing the delay of refresh rate transitions to a second time period, the second time period being shorter than the first time period (1210). The method can include, after expiration of the second time period, changing the refresh rate from the second frequency to the first frequency based on a second change of the graphic intensity (1212).

According to some examples, the low encoded intensity condition can include at least a predefined proportion of pixels having encoded intensities equal to or less than a predefined encoded intensity threshold.

According to some examples, the low encoded intensity condition can include a sum of band values meeting a predefined sum threshold. The sum of band values can include a number of pixels with encoded intensities within a first range multiplied by a first weighting factor plus a number of pixels with encoded intensities within a second range multiplied by a second weighting factor.

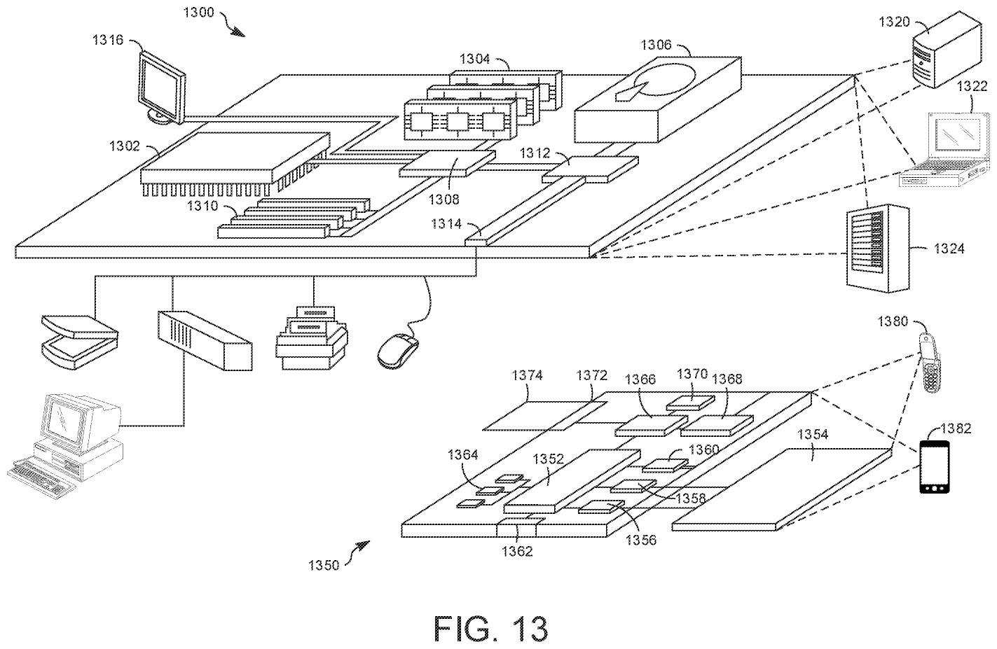

FIG. 13 shows an example of a generic computer device 1300 and a generic mobile computer device 1350, which may be used with the techniques described here. Either of the computer devices 1300, 1350 can be examples of the computing system 1000. Computing device 1300 is intended to represent various forms of digital computers, such as laptops, desktops, tablets, workstations, personal digital assistants, televisions, servers, blade servers, mainframes, and other appropriate computing devices. Computing device 1350 is intended to represent various forms of mobile devices, such as personal digital assistants, cellular telephones, smart phones, and other similar computing devices. Either of the computing devices 1300, 1350 can be an example of the computing system 1000. The components shown here, their connections and relationships, and their functions, are meant to be exemplary only, and are not meant to limit implementations of the inventions described and/or claimed in this document.

Computing device 1300 includes a processor 1302, memory 1304, a storage device 1306, a high-speed interface 1308 connecting to memory 1304 and high-speed expansion ports 1310, and a low speed interface 1312 connecting to low speed bus 1314 and storage device 1306. The processor 1302 can be a semiconductor-based processor. The memory 1304 can be a semiconductor-based memory. Each of the components 1302, 1304, 1306, 1308, 1310, and 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as display 1316 coupled to high speed interface 1308. In other implementations, multiple processors and/or multiple buses may be used, as appropriate, along with multiple memories and types of memory. Also, multiple computing devices 1300 may be connected, with each device providing portions of the necessary operations (e.g., as a server bank, a group of blade servers, or a multi-processor system).

The memory 1304 stores information within the computing device 1300. In one implementation, the memory 1304 is a volatile memory unit or units. In another implementation, the memory 1304 is a non-volatile memory unit or units. The memory 1304 may also be another form of computer-readable medium, such as a magnetic or optical disk.

The storage device 1306 is capable of providing mass storage for the computing device 1300. In one implementation, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1304, the storage device 1306, or memory on processor 1302.

The high speed controller 1308 manages bandwidth-intensive operations for the computing device 1300, while the low speed controller 1312 manages lower bandwidth-intensive operations. Such allocation of functions is exemplary only. In one implementation, the high-speed controller 1308 is coupled to memory 1304, display 1316 (e.g., through a graphics processor or accelerator), and to high-speed expansion ports 1310, which may accept various expansion cards (not shown). In the implementation, low-speed controller 1312 is coupled to storage device 1306 and low-speed expansion port 1314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. It may also be implemented as part of a rack server system 1324. In addition, it may be implemented in a personal computer such as a laptop computer 1322. Alternatively, components from computing device 1300 may be combined with other components in a mobile device (not shown), such as device 1350. Each of such devices may contain one or more of computing device 1300, 1350, and an entire system may be made up of multiple computing devices 1300, 1350 communicating with each other.

Computing device 1350 includes a processor 1352, memory 1364, an input/output device such as a display 1354, a communication interface 1366, and a transceiver 1368, among other components. The device 1350 may also be provided with a storage device, such as a microdrive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. The processor may provide, for example, for coordination of the other components of the device 1350, such as control of user interfaces, applications run by device 1350, and wireless communication by device 1350.

Processor 1352 may communicate with a user through control interface 1358 and display interface 1356 coupled to a display 1354. The display 1354 may be, for example, a TFT LCD (Thin-Film-Transistor Liquid Crystal Display) or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may be provided in communication with processor 1352, so as to enable near area communication of device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium or media, a volatile memory unit or units, or a non-volatile memory unit or units. Expansion memory 1374 may also be provided and connected to device 1350 through expansion interface 1372, which may include, for example, a SIMM (Single In Line Memory Module) card interface. Such expansion memory 1374 may provide extra storage space for device 1350, or may also store applications or other information for device 1350. Specifically, expansion memory 1374 may include instructions to carry out or supplement the processes described above, and may include secure information also. Thus, for example, expansion memory 1374 may be provided as a security module for device 1350, and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, or memory on processor 1352, that may be received, for example, over transceiver 1368 or external interface 1362.

Device 1350 may communicate wirelessly through communication interface 1366, which may include digital signal processing circuitry where necessary. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1368. In addition, short-range communication may occur, such as using a Bluetooth, WiFi, or other such transceiver (not shown). In addition, GPS (Global Positioning System) receiver module 1370 may provide additional navigation- and location-related wireless data to device 1350, which may be used as appropriate by applications running on device 1350.

Device 1350 may also communicate audibly using audio codec 1360, which may receive spoken information from a user and convert it to usable digital information. Audio codec 1360 may likewise generate audible sound for a user, such as through a speaker, e.g., in a handset of device 1350. Such sound may include sound from voice telephone calls, may include recorded sound (e.g., voice messages, music files, etc.) and may also include sound generated by applications operating on device 1350.

The computing device 1350 may be implemented in a number of different forms, as shown in the figure. For example, it may be implemented as a cellular telephone 1380. It may also be implemented as part of a smart phone 1382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A method comprising:
determining that a first frame for display on an emissive display meets a low encoded intensity condition;
based on the determination that the first frame meets the low encoded intensity condition, disabling refresh rate transitions when displaying multiple frames on the emissive display;
while the refresh rate transitions are disabled, maintaining a refresh rate while changing a graphic intensity;
determining that a second frame does not meet the low encoded intensity condition;
based on the determination that the second frame does not meet the low encoded intensity condition, enabling refresh rate transitions when displaying multiple frames on the emissive display; and
while the refresh rate transitions are enabled, changing the refresh rate for the emissive display based on the graphic intensity changing.

2. The method of claim 1, wherein the low encoded intensity condition includes a predefined encoded intensity threshold.

3. The method of claim 1, wherein the low encoded intensity condition includes at least a predefined proportion of pixels having encoded intensities equal to or less than a predefined encoded intensity threshold.

4. The method of claim 3, wherein the predefined proportion is based on a brightness level of the display when displaying the respective frame.

5. The method of claim 3, or wherein the encoded intensities of the pixels are determined based on a weighted average of red values, green values, and blue values, the green values being preferably weighted more heavily than the red values and being preferably weighted more heavily than the blue values.

6. The method of claim 1, wherein the low encoded intensity condition includes a sum of band values meeting a predefined sum threshold, the sum of band values including a number of pixels with encoded intensities within a first range multiplied by a first weighting factor plus a number of pixels with encoded intensities within a second range multiplied by a second weighting factor.

7. The method of claim 6, wherein the predefined sum threshold is based on a brightness level of the display on which the graphic intensity changes.

8. The method of claim 1, further comprising:
determining that a third frame meets the low encoded intensity condition, the third frame being displayed consecutively after the first frame and before the second frame, wherein the disablement of refresh rate transitions is based on the first frame meeting the low encoded intensity condition and the third frame meeting the low encoded intensity condition.

9. The method of claim 1, further comprising:
determining that a third frame does not meet the low encoded intensity condition, the third frame being displayed consecutively after the second frame,
wherein the enablement of the refresh rate transitions is based on the determination that the second frame does not meet the low encoded intensity condition and the determination that the third frame does not meet the low encoded intensity condition.

10. The method of claim 1, wherein the emissive display includes an active-matrix organic light-emitting diode (AMOLED) display.

11. The method of claim 1, further comprising changing a peak luminance of at least one pixel after changing the refresh rate.

12. The method of claim 1, wherein the graphic intensity changes based on a change of a type of application presented by a display.

13. A method comprising:
determining that a first frame for display on an emissive display meets a low encoded intensity condition;
based on the determination that the first frame meets the low encoded intensity condition, setting a delay of refresh rate transitions when displaying multiple frames on the emissive display to a first time period;
after expiration of the first time period, changing a refresh rate for the emissive display from a first frequency to a second frequency based on a first change of a graphic intensity;
determining that a second frame does not meet the low encoded intensity condition;
based on the determination that the second frame has not met the low encoded intensity condition, changing the delay of refresh rate transitions to a second time period, the second time period being shorter than the first time period; and
after expiration of the second time period, changing the refresh rate from the second frequency to the first frequency based on a second change of the graphic intensity.

14. The method of claim 13, wherein the low encoded intensity condition includes at least a predefined proportion of pixels having encoded intensities equal to or less than a predefined encoded intensity threshold.

15. The method of claim 13, wherein the low encoded intensity condition includes a sum of band values meeting a predefined sum threshold, the sum of band values including a number of pixels with encoded intensities within a first range multiplied by a first weighting Page 6 of 7 factor plus a number of pixels with encoded intensities within a second range multiplied by a second weighting factor.

16. A non-transitory computer-readable storage medium comprising instructions stored thereon that, when executed by at least one processor, are configured to cause a computing system to perform the method of claim 1.

17. A computing system comprising:
at least one processor; and
a non-transitory computer-readable storage medium comprising instructions stored thereon that, when executed by the at least one processor, are configured to cause the computing system to perform the method of claim 1.
